(19) United States
(12) Patent Application Publication
(10) Pub. No.: US 2010/0302374 A1
(43) Pub. Date: Dec. 2, 2010

(54) AUTHENTICATION DEVICE AND AUTHENTICATION SERVER

(75) Inventor: Nobuyuki Ebara, Maebashi (JP)

Correspondence Address: GREER, BURNS & CRAIN, 300 S WACKER DR, 25TH FLOOR, CHICAGO, IL, 60606, US

(73) Assignee: FUJITSU FRONTECH LIMITED, Tokyo (JP)

(21) Appl. No.: 12/712,851

(22) Filed: Feb. 25, 2010

(30) Foreign Application Priority Data
May 29, 2009 (JP) 2009-131013

(51) Int. Cl. H04N 7/18

(52) U.S. Cl. 348/156; 348/E07.085

(57) ABSTRACT

The proposed authentication device includes: a reading unit for reading a card ID of a card inserted in the device; a photographing unit for photographing the entirety of the card from the front; an device information transmission unit for transmitting an device ID and the read card ID to an external authentication server; a retrieving unit for retrieving a region designated by endpoint coordinates corresponding to a required security level received from the authentication server from card image data obtained by the photographing unit; and an authentication range transmission unit for transmitting the device ID, the read card ID, and image data of the retrieved region to the authentication server.

### CROSS-REFERENCE TO RELATED APPLICATION

This application is based upon and claims the benefit of priority of the prior Japanese Patent Application No. 2009-131013, filed on May 29, 2009, the entire contents of which are incorporated herein by reference.

### FIELD

The present invention relates to an authentication technology that employs personal identification information recorded in a card and image data of the card.

### BACKGROUND

Conventionally, when entering a building, authentication is performed near an entrance using various methods. In one method, authentication is performed by manually entering ID information. In another method, authentication is performed by reading ID information recorded in a card.

However, in regard to an authentication method in which ID information is manually entered, anyone can be authenticated if she/he obtains ID information. This nullifies a security function.

In regard to an authentication method in which ID information is entered by reading ID information in a card, if the card falls into a stranger's hands and a counterfeit is made, then authentication can be performed using the counterfeit card. This also nullifies a security function.

In other words, in a security system in which authentication is performed on the basis of manually entered ID information, card reading, or the like, security cannot be ensured if ID information is leaked.

In view of the matters described above, the accuracy of authentication may be improved by further employing image data (biometric data, a card image, or the like) for authentication. In this case, however, since image data is also incorporated as a portion of authentication information, a large amount of data is dealt with. Therefore, there is a problem in which a load of authentication processing (loads of a line bandwidth and of a CPU that executes the processing) is applied.

As a related art other than that described above, patent document 1 indicates a biometric authentication transaction device that stores a plurality of biometric information extracted from a portion of a living body in advance, uses some of the plurality of biometric information in a transaction in which a low level of creditworthiness is sufficient for authentication, and additionally uses other pieces of the plurality of information in a transaction in which a low level of creditworthiness is sufficient for authentication but in which it is difficult to identify a person by comparing only the biometric information above, or in a transaction in which a high level of creditworthiness is required for authentication.

### Patent Document 1:

### Japanese Laid-open Patent Publication No. 2006-268086

### SUMMARY

The present invention is made in view of the problems above. The object of the present invention is to provide an authentication device and an authentication server that can reduce the loads of authentication processing while ensuring a necessary security level.

The proposed authentication device comprises: a reading unit for reading a card ID of a card inserted in the device; a photographing unit for photographing the entirety of the card from the front; an device information transmission unit for transmitting an device ID and the read card ID to an external authentication server; a retrieving unit for retrieving a region designated by endpoint coordinates corresponding to a required security level received from the authentication server from card image data obtained by the photographing unit; and an authentication range transmission unit for transmitting the device ID, the read card ID, and image data of the retrieved region to the authentication server.

The proposed authentication server comprises a storage unit for storing: authentication device information that includes an authentication device ID and identification information of a region used for authentication; and card information that includes a card ID, card image data made by photographing the entirety of a card from the front, and identification information of each region in the card image data. The identification information of a region includes image data of the region and endpoint coordinates that designate the region. In addition, the authentication server comprises an authentication range setting unit, an authentication range notification unit, an authentication processing unit, and an authentication result notification unit.

When the authentication range setting unit receives an authentication device ID and a card ID through a communication line from an authentication device, it searches authentication device information in the storage unit by using the received authentication device ID as a key, obtains identification information of a region that corresponds to a found authentication device ID, searches card information in the storage unit by using the received card ID as a key, and obtains endpoint coordinates of the obtained identification information of the region and image data of the region which correspond to a found card ID.

The authentication range notification unit notifies the authentication device of obtained endpoint coordinates.

When the authentication processing unit receives from the authentication device an authentication device ID, a card ID, and image data of a region extracted on the basis of the endpoint coordinates, it judges whether or not the received image data of the region is identical with image data of the region which is obtained by the authentication range setting unit.

The authentication result notification unit gives an authentication OK notice to the authentication device when it is judged that the received image data of the region is identical with the obtained image data of the region, and gives an authentication NG notice to the authentication device when it is judged that the received image data of the region is not identical with the obtained image data of the region.

### BRIEF DESCRIPTION OF DRAWINGS

FIG. 1 is a block diagram showing a configuration of an authentication system according to one embodiment of the present invention.

FIG. 2 is a perspective view of an authentication device.

FIG. 3 is a front view of a card.

FIG. 4 is a diagram showing image data of a card.

FIG. 5 is a diagram showing designated regions in image data of a card.

FIG. 6 is a diagram showing a data organization of an authentication device information table.

FIG. 7 is a diagram showing a data organization of a card information table.

FIG. 8 is a diagram showing a system flow of authentication processing.

### DESCRIPTION OF EMBODIMENT

On the basis of the drawings, details of the embodiment of the present invention will be described in the following.

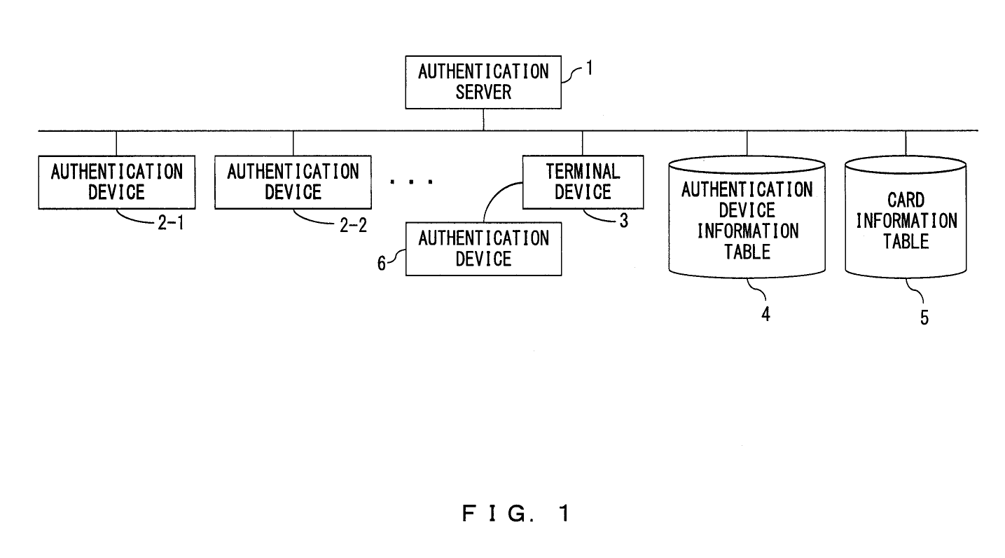

FIG. 1 is a block diagram showing a configuration of an authentication system according to one embodiment of the present invention.

As shown in FIG. 1, the authentication system is configured by, for example, connecting an authentication server 1 through a communication line (exclusive line) to a plurality of authentication devices 2-1, 2-2, and the like, each of which is provided near an entrance of each room in the building of a certain company.

An employee of the company takes a card (i.e., employee ID card) with her/him, and has the authentication devices read data in the card to perform authentication when she/he enters the building or each room in the building.

In the present embodiment, it is assumed that the security level changes in accordance with location in the building. An authentication device information table 4 in FIG. 1 sets a security level of each of the authentication devices provided near the entrance of each room in the building.

For each of the cards possessed by employees of the company, a card information table 5 includes data of the entire image of the card which is created by photographing the entirety of the card from the front in such a way that a head shot, a company logo, and the like are contained in the data, and includes image data of a designated region in the data of the entire image.

A terminal device 3 is connected through a communication line to the authentication device information table 4 and the card information table 5.

Via the terminal device 3, it is possible to set (register) required content in the authentication device information table 4 or to change the content being set.

The terminal device 3, which is connected through a cable to an authentication device 6 (this device may be the same as an authentication device provided near the entrance of each of the rooms), can perform, via the authentication device 6, a process of reading magnetic stripe data (hereinafter simply referred to as “MS data”) of a card (employee ID card) and reading entire-image data captured by photographing the card from the front so as to register them in the card information table 5. If an IC chip is incorporated in the card, the data recorded in the IC chip is used instead of MS data.

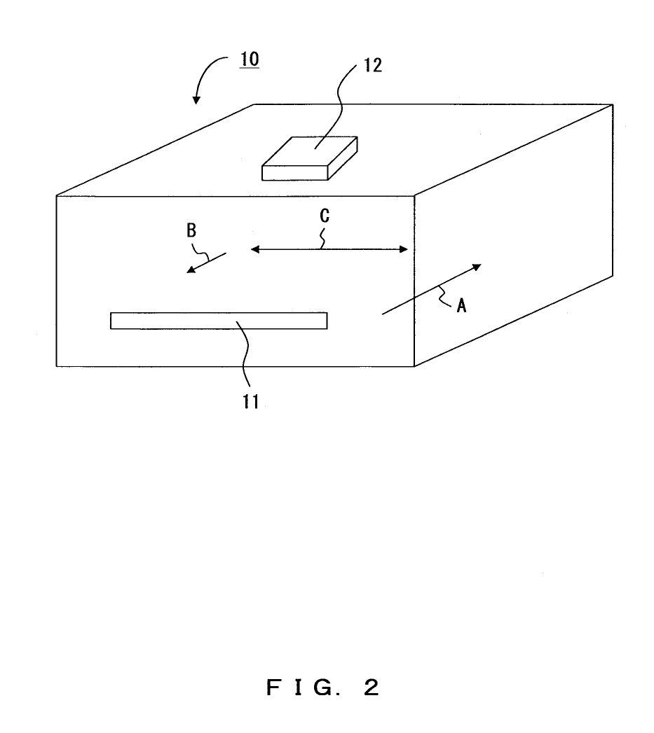

FIG. 2 is a perspective view of an authentication device.

As shown in FIG. 2, an authentication device 10 comprises: a slot 11 through which a card is inserted to read data; an internal reading head (not shown) for reading MS data; and a photographing unit 12 for photographing the card from the front.

Although not shown in FIG. 2, the authentication device 10 further comprises: an device information transmission unit for transmitting an device ID and a read card ID to an authentication server; a retrieving unit for retrieving a region designated by endpoint coordinates corresponding to a required security level received from the authentication server from card image data obtained by the photographing unit; and an authentication range transmission unit for transmitting the device ID, the read card ID, and image data of the retrieved region to the authentication server.

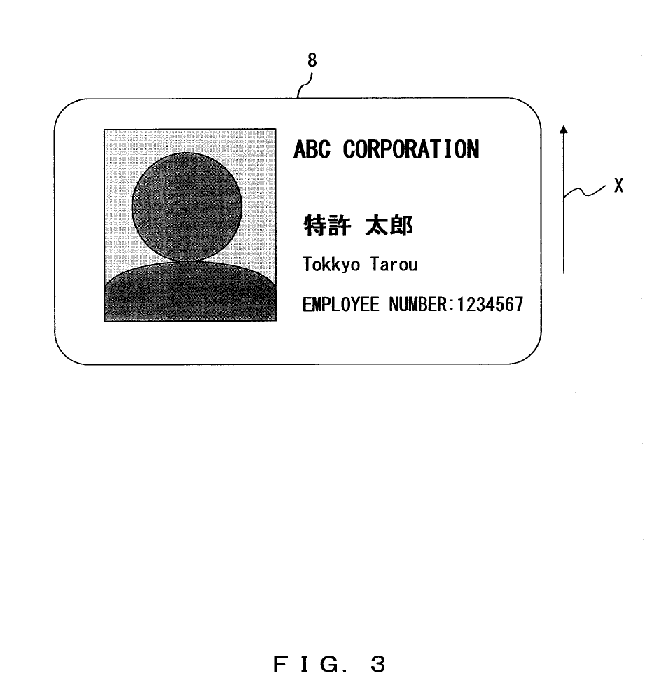

FIG. 3 is a front view of a card.

The width of the slot 11 in FIG. 2 corresponds to the length of the longer direction of a card 8 in FIG. 3. A shorter length end of the card 8 shown in FIG. 3 is inserted in the depth direction (indicated as arrow A in FIG. 2) of the authentication device 10 by a conveyance unit (not shown) until the card 8 arrives at a predetermined position in the depth direction where MS data is read.

Then, the movement of the reading head in the two directions indicated as arrow C in FIG. 2 allows for the reading of the MS data in the card 8, which is performed at the predetermined position in the depth direction.

After this, the conveyance unit moves the card 8 to a position (in the direction of arrow B in FIG. 2) before the predetermined position and at which the entirety of the front face of the card can be photographed when the photographing unit 12 irradiates the card 8.

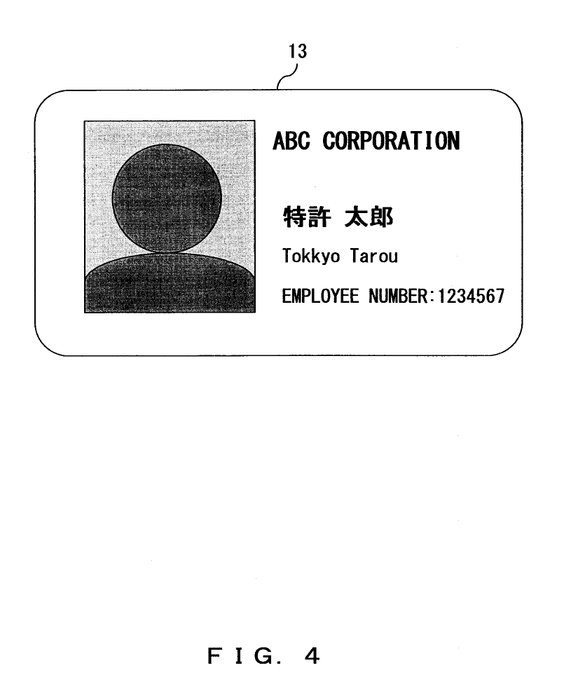

The entirety of the front face of the card 8 is then photographed by the photographing unit 12 at the position in the depth direction at which the entirety of the front face of the card can be photographed, such that image data 13 made by photographing the entirety of the card 8 from the front (this may be referred to as “card image data”) as shown in FIG. 4 is saved in a memory (not shown) of the authentication device 10.

In regard to each of the authentication devices in the system, it is common to insert the card 8 into the authentication device 10 in FIG. 2 in such a way that the front face, including a head shot, a company logo, and the like, is kept facing upward and that the direction of arrow X in FIG. 3 is identical with the direction of arrow A in FIG. 2.

If a card having a white background color as shown in FIG. 4 is used, it is assumed that the color of the portion in the authentication device 10 which is in the vicinity of the edge of the card is adjusted such that the edge of the card is clarified when the card is irradiated in photographing.

For example, when an employee enters a room, and when card information is registered, the operations above are commonly performed. When card information is registered, the following tasks are additionally performed.

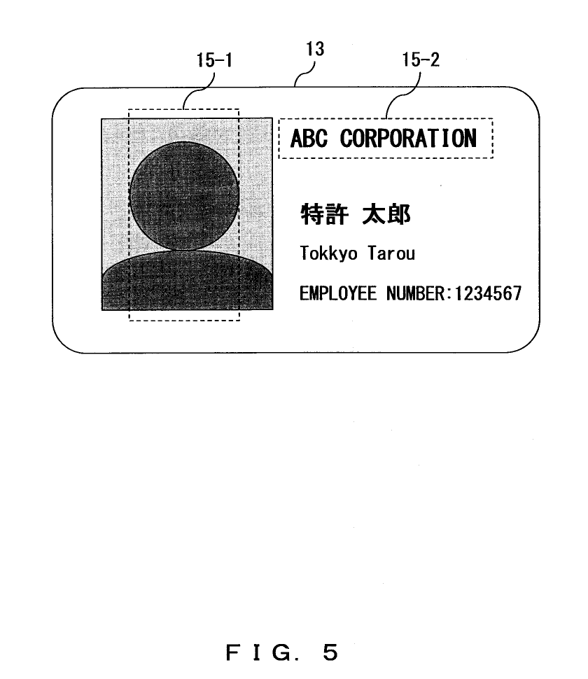

The image data 13 saved in the memory of the authentication device 10 (=authentication device 6 in FIG. 1) is output so as to be displayed in the display unit of the terminal device 3. Then, the operator of the terminal device 3 designates, for example, two rectangular regions 15-1 and 15-2 in the image data 13 as shown in FIG. 5 by designating pairs of endpoint coordinates (i.e., the bottom-right point and the top-left point or the top-right point and the bottom-left point of a rectangle) using a mouse or the like.

As will be described later, the two designated rectangular regions 15-1 and 15-2 are retrieved from the original image data 13; and the regions 15-1 and 15-2 as the image data of the designated regions are associated with the original data 13 together with the endpoint coordinates and are saved in the card information table 5 in FIG. 1. As will be described later, in the present embodiment, four rectangular regions are designated. In FIG. 5, however, only two rectangular regions are indicated so as to simplify the illustration.

In view of the fact that cards, such as an employee ID card, include a head shot, a company logo, and the like at the same positions in image data made by photographing a card from the front, a template may be prepared in advance and rectangular regions may be automatically designated using this template instead of designating them in each card as described above.

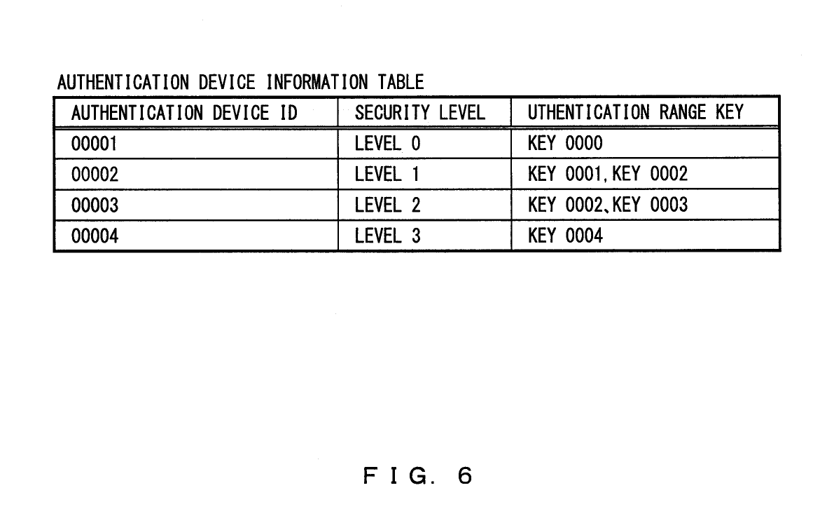

FIG. 6 is a diagram showing a data organization of an authentication device information table.

As shown in FIG. 6, the authentication device information table contains an authentication device ID for identifying an authentication device, a security level, and an authentication region key.

As the number increases, the security level declines. The authentication region key is a key that identifies an authentication target range in image data (card image data) made by photographing the entirety of a card from the front.

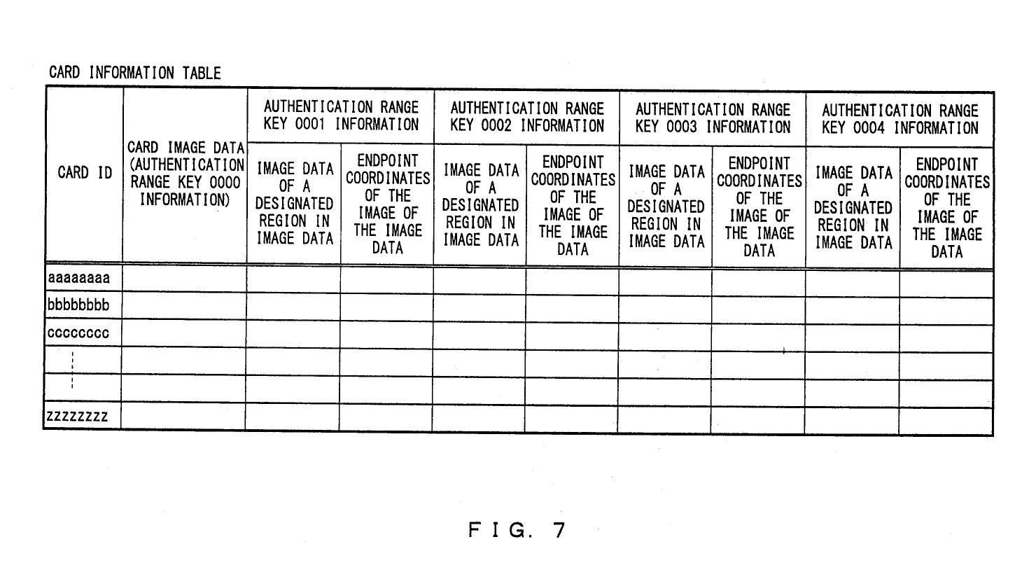

FIG. 7 is a diagram showing a data organization of a card information table.

As shown in FIG. 7, the card information table contains items that include a card ID for identifying a card, card image data of the card (image data corresponding to authentication region key 0000), authentication region key 0001 information, authentication region key 0002 information, authentication region key 0003 information, and authentication region key 0004 information.

As described above, the operator of the terminal device in FIG. 1 designates an authentication target range (“rectangle” in the present embodiment) in card image data; and a task is performed in which several patterns (four patterns in the present embodiment) of the authentication target range are registered in the card information table.

In this registration task, when endpoint coordinates are designated to register the four patterns that were designated as the authentication target range, linking (naming) is automatically performed for each of the registered image data patterns such that they are referred to as authentication region keys 0000, 0001, 0002, 0003 and 0004 in the order of the larger amount of data first. Either the authentication server 1 in FIG. 1 or the terminal device 3 may perform this linking process.

Since authentication region key 0000 always corresponds to image data (card image data) made by photographing the entirety of the card from the front, it does not have an endpoint coordinate. However, a reference point (starting position) of the card coordinate system will of course be determined using similar logic between the authentication server side and the authentication device side.

In regard to each piece of information of the authentication region keys 0001, 0002, 0003 and 0004, image data of each region is registered together with a pair of endpoint coordinates that are viewed from the reference point (starting point) of the card coordinate system and that designate each region.

Although not shown in FIG. 1, the authentication server 1 comprises an authentication range setting unit, an authentication range notification unit, an authentication processing unit, and an authentication result notification unit.

When the authentication range setting unit above receives an authentication device ID and a card ID from an authentication device through a communication line, it searches the authentication device information table in FIG. 6 using the received authentication device ID as a key, obtains identification information of a region which corresponds to a found authentication device ID, searches the card information table in FIG. 7 using the received card ID as a key, obtains endpoint coordinates of the obtained identification information of the region which corresponds to a found card ID, and obtains image data of the region of the obtained identification information of the region which corresponds to the found card ID.

The authentication range notification unit above notifies the authentication device above of the obtained endpoint coordinates.

When the authentication processing unit receives from the authentication device above the authentication device ID, the card ID, and image data of the region which is retrieved on the basis of the endpoint coordinates, it judges whether or not the received image data of the region is identical to the image data of the region obtained by the authentication range setting unit above.

When it is judged that the received image data of the region is identical to the obtained image data of the region, the authentication result notification unit above gives an authentication OK notice to the authentication device above; and when it is judged that the received image data of the region is not identical to the obtained image data of the region, it gives an authentication NG notice to the authentication device above.

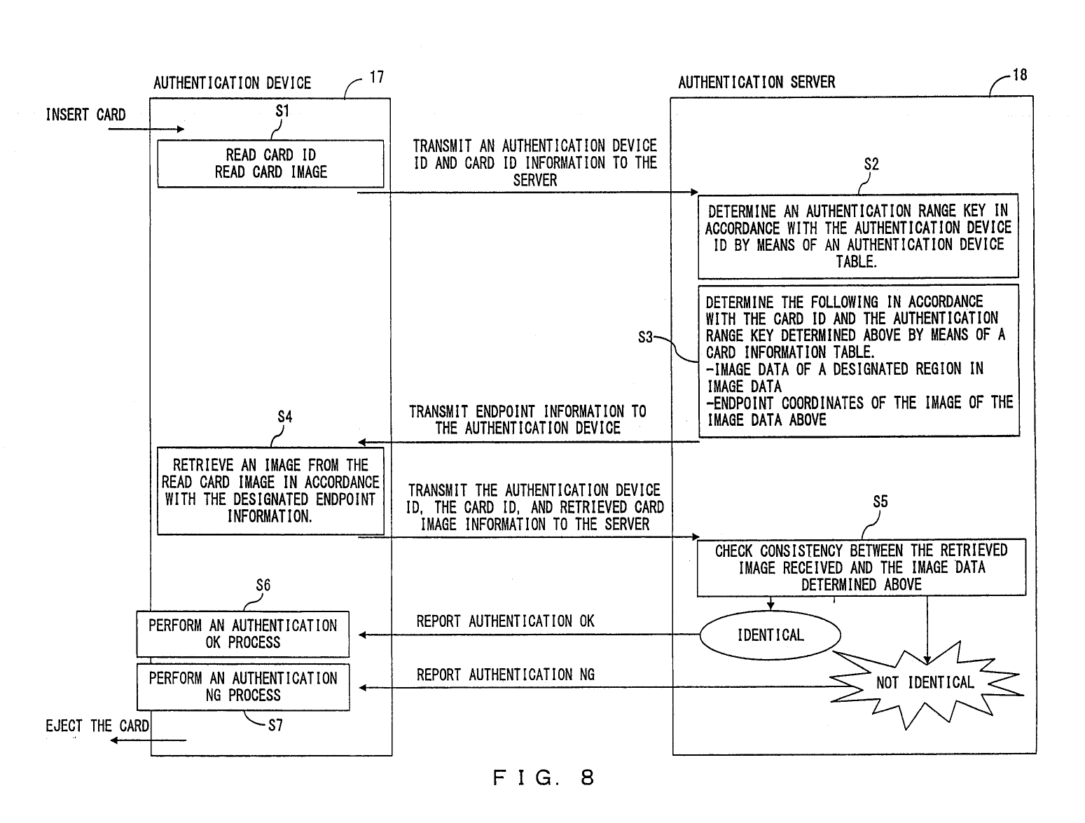

FIG. 8 is a diagram showing a system flow of authentication processing.

In FIG. 8, when a card is inserted in an authentication device 17 through a slot, MS data is read by a reading head and a card ID is extracted from the MS data in step S1. The entirety of the card is photographed from the front by the photographing unit, and the image data (card image data) that is the result of the photographing is saved in a memory. A process is then performed for the saved card image data in which a reference point (starting point) for the card coordinate system is determined. In addition, the authentication device ID of the authentication device 17 and the extracted card ID are transmitted to an authentication sever 18.

After receiving the authentication device ID and the card ID, the authentication server 18 searches the authentication device information table in FIG. 6 using the received authentication device ID as a key and obtains an authentication region key corresponding to a found authentication device ID in step S2.

In step S3, the authentication server 18 searches the card information table in FIG. 7 using the received card ID as a key, obtains endpoint coordinates of the authentication region key XXXX obtained in step S2 which correspond to a found card ID, and obtains image data of a region of the authentication region key XXXX which corresponds to the found card ID.

The endpoint coordinates obtained in step S3 are transmitted from the authentication server 18 to the authentication device 17.

For example, when a received authentication device ID corresponds to “security level=level 1” in FIG. 6, the two keys 0001 and 0002, i.e., endpoint coordinates and image data of the regions of authentication region key 0001 information and authentication region key 0002 information in FIG. 7 are obtained.

As another example, when a received authentication device ID corresponds to “security level=level 3” in FIG. 6, key 0004, i.e., endpoint coordinates and image data of the region of authentication region key 0004 information in FIG. 7, is obtained.

As another example, when a received authentication device ID corresponds to “security level=level 0” in FIG. 6, key 0000 is obtained. Key 0000 is authentication region key 0000 information in FIG. 7, which is card image data. Since the data is an entire image, endpoint coordinates do not need to be designated. In this case, instead of endpoint coordinates being transmitted from the authentication server 18 to the authentication device 17, information indicating that an entire image is required is transmitted.

After receiving endpoint coordinates from the authentication server 18, the authentication device 17 retrieves a rectangular region designated by the received endpoint coordinates from the card image data saved in the memory and transmits the authentication device ID of the device 17, the card ID, and image data of the retrieved region to the authentication server 18 in step S4.

After receiving the authentication device ID, the card ID, and the image data of the retrieved region, the authentication server 18 judges whether or not the received image data of the region and the image data of the region obtained in step S3 are identical to each other in step S5.

When it is judged that the received image data of the region is identical to the obtained image data of the region (or when every image is identical to its corresponding image if there is a plurality of image data from several regions, as in the case of security level 1 or 2 in FIG. 6), an authentication OK notice is sent from the authentication server 18 to the authentication device 17.

After receiving this notice, the authentication device 17 performs a process for an authentication OK, ejects the card, and terminates the processing series in step S6.

Meanwhile, when it is judged that the received image data of the region is not identical to the obtained image data of the region (or when one or more images are not identical to their corresponding images if there is a plurality of image data from several regions, as in the case of security level 1 or 2 in FIG. 6), an authentication NG notice is sent from the authentication server 18 to the authentication device 17.

After receiving this notice, the authentication device 17 performs a process for an authentication NG, ejects the card, and terminates the processing series in step S7.

What is claimed is:

1. An authentication device comprising:
a reading unit for reading a card ID of a card inserted in the device;
a photographing unit for photographing an entirety of the card from a front;
an device information transmission unit for transmitting an device ID and the read card ID to an external authentication server;
a retrieving unit for retrieving a region designated by endpoint coordinates corresponding to a required security level received from the authentication server from card image data obtained by the photographing unit; and
an authentication range transmission unit for transmitting the device ID, the read card ID, and image data of the retrieved region to the authentication server.

2. An authentication server comprising
a storage unit for storing: authentication device information that includes an authentication device ID and identification information of a region used for authentication; and card information that includes a card ID, card image data made by photographing an entirety of a card from a front, and identification information of each region in the card image data, wherein
the identification information of the region includes image data of the region and endpoint coordinates that designate the region, the server further comprising:
an authentication range setting unit for searching authentication device information in the storage unit by using an authentication device ID as a key, for obtaining identification information of a region that corresponds to a found authentication device ID, for searching card information in the storage unit by using a card ID as a key, and for obtaining endpoint coordinates of the obtained identification information of the region and image data of the region which correspond to a found card ID, when the authentication range setting unit receives the authentication device ID and the card ID from an identification device through a communication line;
an authentication range notification unit for notifying the authentication device of the obtained endpoint coordinates;
an authentication processing unit for judging whether or not image data of a region retrieved on the basis of the endpoint coordinates is identical to image data of the region obtained by the authentication range setting unit, when the authentication processing unit receives from the authentication device an authentication device ID, a card ID, and the image data of the region that was retrieved on the basis of the endpoint coordinates; and
an authentication result notification unit for giving an authentication OK notice to the authentication device when it is judged that the received image data of the region is identical to the obtained image data of the region, and for giving an authentication NG notice to the authentication device when it is judged that the received image data of the region is not identical to the obtained image data of the region.

3. The authentication server according to claim 2, wherein:
when there is a plurality of image data of different regions, the authentication processing unit judges that the received image data of the different regions is identical to the obtained image data of the different regions if every image in the received image data of the different regions and the obtained image data of the different regions is identical to its corresponding image; and
when there is a plurality of image data of the different regions, the authentication processing unit judges that the received image data of the different regions is not identical to the obtained image data of the different regions if one or more images in the received image data of the different regions and the obtained image data of the different regions are not identical to their corresponding images.

4. The authentication server according to claim 2, wherein:
the region is a rectangular region; and
the endpoint coordinates are a bottom-right point and a top-left point or a top-right point and a bottom-left point of the rectangle.
